(19) United States
(12) Patent Application Publication
(10) Pub. No.: US 2025/0238354 A1
(43) Pub. Date: Jul. 24, 2025

(54) LOW-CODE TESTING OF INTERACTIVE WEB APPLICATIONS

(71) Applicant: Snowflake Inc., Bozeman, MT (US)

(72) Inventors: Joshua K. Carroll, Oakland, CA (US); Kenneth E. McGrady, JR., Seattle, WA (US); Amanda Ann Walker, Berkeley, CA (US)

(21) Appl. No.: 18/421,865

(22) Filed: Jan. 24, 2024

(51) Int. Cl. G06F 11/36; G06F 8/38; G06F 16/28

(52) U.S. Cl. CPC G06F 11/3692; G06F 8/38; G06F 11/3688; G06F 16/284

(57) ABSTRACT

A low-code web application testing platform is provided. The low-code web application testing platform automates the testing process of web applications. The low-code web application testing platform executes a script that simulates the frontend of a web application, capturing output messages that detail the UI elements. The low-code web application testing platform then interprets these messages to construct a navigable structure that represents the application's UI. To emulate user interactions, the low-code web application testing platform performs test actions within this structure, subsequently rerunning the script with these interactions to capture additional output messages that reflect the application's response. The culmination of this process is the generation of a test report, which is based on the application's reaction to the emulated interactions, providing a comprehensive assessment of the application's functionality and user experience.

### TECHNICAL FIELD

Examples of the disclosure relate generally to databases and, more specifically, to testing applications.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems. Users may develop applications that execute on data platforms. It is desirable to test a user developed applications before they execute on the data platforms.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider system, according to some examples.

FIG. 2 is a block diagram illustrating components of a compute service manager, according to some examples.

FIG. 3 is a block diagram illustrating components of an execution platform, according to some examples.

FIG. 4 illustrates a low-code web application testing method, according to some examples.

FIG. 5 illustrates a low-code web application testing platform, according to some examples.

FIG. 6 illustrates a navigable structure, according to some examples.

FIG. 7 illustrates a diagrammatic representation of a machine in the form of a computer system within which a set of instructions may be executed for causing the machine to perform any one or more of the methodologies discussed herein, according to some examples.

### DETAILED DESCRIPTION

Data platforms, which may be structured as on-premises or network-based systems like cloud-based data platforms, are utilized for a wide array of data storage and access operations. These platforms can support various data processing types, including Online Transactional Processing (OLTP), Online Analytical Processing (OLAP), or a combination thereof, and may comprise relational database management systems (RDBMS) or other database management systems.

In the context of these data platforms, users often develop applications that execute on the platforms. It is desirable to test these user-developed applications to ensure they function correctly before they are executed on the data platforms. A low-code web application testing platform provides capabilities to simulate the application's frontend, capture and analyze UI elements, and emulate user interactions to validate the application's behavior. This testing allows a developer to identify and mitigate issues before the applications are deployed in a live environment. A low-code web application testing platform in accordance with examples of this disclosure provides methods and systems for low-code automated testing of web applications aimed to address these needs by providing an efficient and effective means to test applications within data platforms.

In some examples, a low-code web application testing platform is configured to perform a series of operations for automated testing of web applications. The platform runs a script to simulate the frontend of a web application, captures output messages that describe the User Interface (UI) elements of the web application's UI, and interprets these messages to form a navigable structure representing the UI. The platform then performs test actions on the navigable structure to emulate user interactions with the UI elements, reruns the script using the user interactions, and captures additional output messages that describe the web application's response to the user interactions. Finally, the platform generates a test report based on the web application's response to the emulated user interactions.

In some examples, the low-code web application testing platform executes the script within a backend web server environment, which is part of the running and rerunning of the script.

In some examples, the low-code web application testing platform utilizes a low-code platform to facilitate the creation of the UI elements of the web application.

In some examples, the low-code web application testing platform captures the output messages and the additional output messages by intercepting messages that are normally sent to a browser client for rendering the UI.

In some examples, the low-code web application testing platform interprets the output messages to form a navigable structure by creating a virtual representation of the UI of the web application that mirrors a structure expected by a browser.

In some examples, the low-code web application testing platform emulates user interactions with the navigable structure by using an Application Programming Interface (API) to emulate the user interactions with the navigable structure.

In some examples, the low-code web application testing platform emulates the user interactions with the UI elements by generating equivalent messages representing user actions.

In some examples, the low-code web application testing platform generates a test report by analyzing the responses of the web application to the emulated user interactions to determine if the response matches one or more expected outcomes.

In some examples, the low-code web application testing platform validates the behavior of the web application by comparing the actual state of the web application after emulated user input with a predetermined expected state.

In some examples, the low-code web application testing platform is implemented within a User Defined Function (UDF) framework, and the web application is a UDF application.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

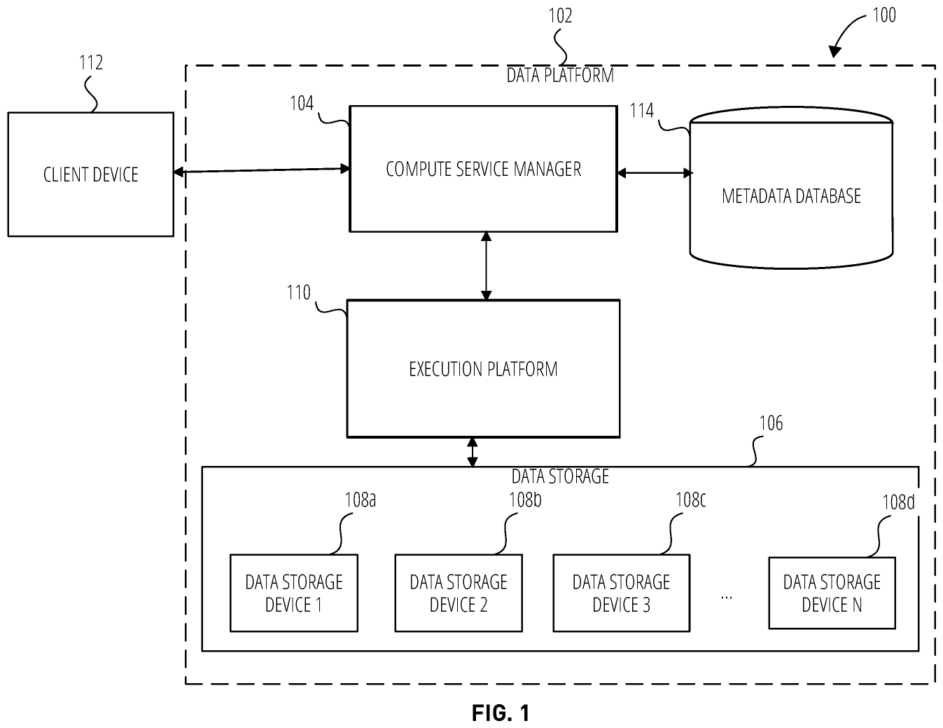

FIG. 1 illustrates an example computing environment 100 that includes a data platform 102 in communication with a client device 112, according to some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a data storage 106, a compute service manager 104, an execution platform 110, and a metadata database 114. The data storage 106 comprises a plurality of computing machines and provides on-demand computer system resources such as data storage and computing power to the data platform 102. As shown, the data storage 106 comprises multiple data storage devices, such as data storage device 1 108a, data storage device 2 108b, data storage device 3 108c, and data storage device N 108d. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters, Amazon S3™ storage systems or any other data storage technology. Additionally, the data storage 106 may include distributed file systems (e.g., Hadoop Distributed File Systems (HDFS)), object storage systems, and the like.

The data platform 102 is used for reporting and analysis of integrated data from one or more disparate sources including the storage devices 1 to N within the data storage 106. The data platform 102 hosts and provides data reporting and analysis services to multiple consumer accounts. Administrative users can create and manage identities (e.g., users, roles, and groups) and use privileges to allow or deny access to identities to resources and services. Generally, the data platform 102 maintains numerous consumer accounts for numerous respective consumers. The data platform 102 maintains each consumer account in one or more storage devices of the data storage 106. Moreover, the data platform 102 may maintain metadata associated with the consumer accounts in the metadata database 114. Each consumer account includes multiple objects with examples including users, roles, privileges, a datastores or other data locations (herein termed a “stage” or “stages”), and the like.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the client device 112. The client device 112 can be used by a user of one of the multiple consumer accounts supported by the data platform 102 to interact with and utilize the functionality of the data platform 102. In some examples, the compute service manager 104 does not receive any direct communications from the client device 112 and only receives communications concerning jobs from a queue within the data platform 102.

The compute service manager 104 is also coupled to metadata database 114. The metadata database 114 stores data pertaining to various functions and examples associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the database storage 106) and the local caches. In some examples, the metadata database 114 include data of metrics describing usage and access by providers and consumers of the data stored on the data platform 102. In some examples, the metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. The execution platform 110 is coupled to the database storage 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle all communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 1 108a to data storage device N 108d are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata database 114, execution platform 110, and data storage 106 are shown in FIG. 1 as individual discrete components. However, each of the compute service manager 104, metadata database 114, execution platform 110, and data storage 106 may be implemented as a distributed system (e.g., distributed across multiple systems/platforms at multiple geographic locations). Additionally, each of the compute service manager 104, metadata database 114, execution platform 110, and data storage 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the data storage 106. It is desirable to retrieve as much data as possible from caches within the execution platform 110 because the retrieval speed is typically faster than retrieving data from the data storage 106.

As shown in FIG. 1, the computing environment 100 separates the execution platform 110 from the data storage 106. In this arrangement, the processing resources and cache resources in the execution platform 110 operate independently of the database storage devices data storage device 1 108a to data storage device N 108d in the data storage 106. Thus, the computing resources and cache resources are not restricted to a specific one of the data storage device 1 108a to data storage device N 108d. Instead, all computing resources and all cache resources may retrieve data from, and store data to, any of the data storage resources in the data storage 106.

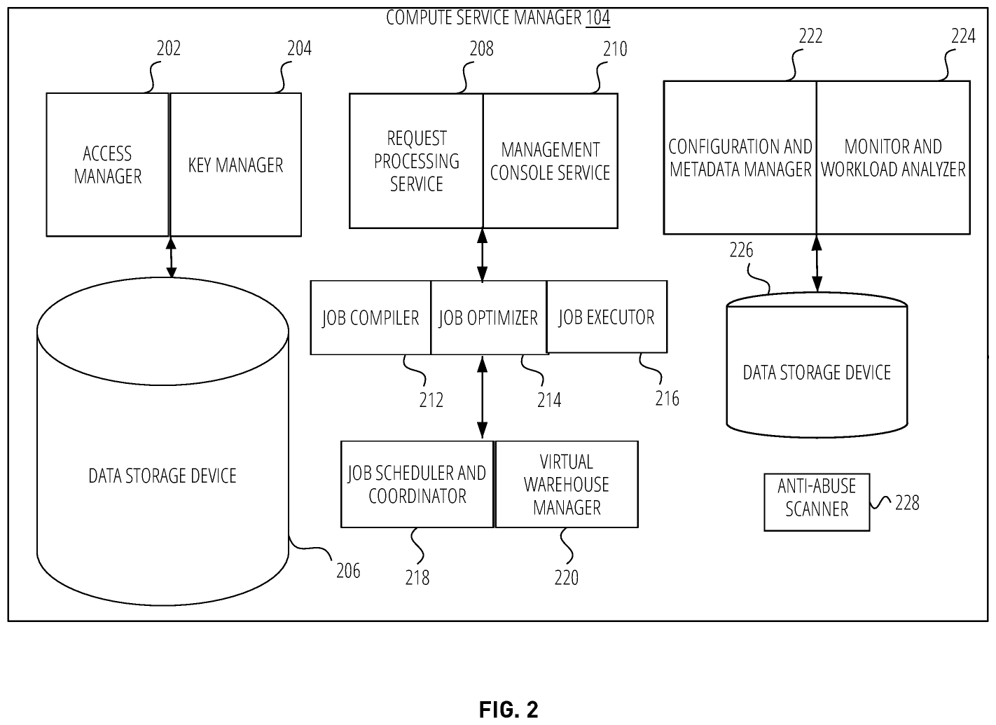

FIG. 2 is a block diagram illustrating components of the compute service manager 104, according to some examples. As shown in FIG. 2, the compute service manager 104 includes an access manager 202, and a key manager 204. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage data storage device 206). As used herein, the remote storage devices may also be referred to as “persistent storage devices” or “shared storage devices.”

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 106.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 104.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in data storage 106, or any other storage device.

The compute service manager 104 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 304a) may need to communicate with another execution node (e.g., execution node 304b), and should be disallowed from communicating with a third execution node (e.g., execution node 316a) and any such illicit communication can be recorded (e.g., in a log or other location). Also, the information stored on a given execution node is restricted to data relevant to the current query and any other data is unusable, rendered so by destruction or encryption where the key is unavailable.

The compute service manager 104 further comprises an anti-abuse scanner 228 that monitors creation of application packages created by content providers of the data platform 102. When a new application package is created by a content provider, the anti-abuse scanner 228 scans the application package to determine if the application package contains content that is harmful, malicious, and the like. If such content is found, the anti-abuse scanner 228 prevents release of the application package by the content provider.

In some examples, the anti-abuse scanner 228 is a component of another system that the compute service manager 104 communicates with via a network of the like.

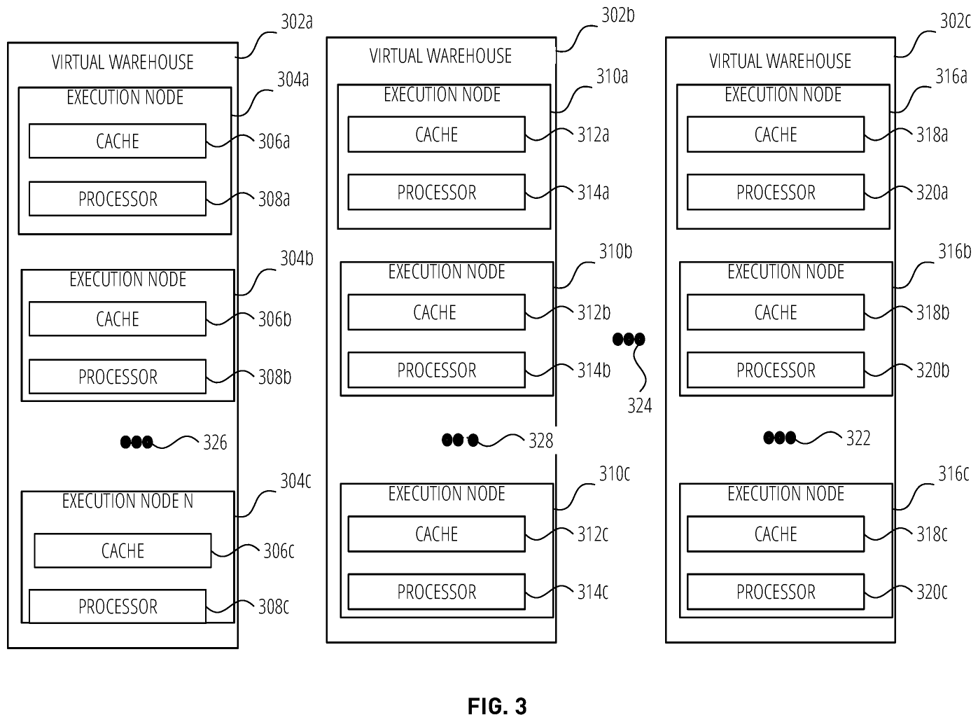

FIG. 3 is a block diagram illustrating components of the execution platform 110, according to some examples. As shown in FIG. 3, the execution platform 110 includes an arbitrary number of virtual warehouses (as indicated by ellipsis 324), including virtual warehouse 302a, virtual warehouse 302b to virtual warehouse 302c. Each virtual warehouse includes an arbitrary number of execution nodes (as indicated by ellipsis 326, ellipsis 328, and ellipsis 322) that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in data storage 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 1 to N shown in FIG. 1. Thus, the virtual warehouses are not necessarily assigned to a specific data storage device 1 to N and, instead, can access data from any of the data storage devices 1 to N within the data storage 106. Similarly, each of the execution nodes shown in FIG. 3 can access data from any of the data storage devices 1 to N. In some examples, a particular virtual warehouse or a particular execution node may be temporarily assigned to a specific data storage device, but the virtual warehouse or execution node may later access data from any other data storage device.

In the example of FIG. 3, virtual warehouse 302a includes a plurality of execution nodes as exemplified by execution node 304a, execution node 304b, and execution node N 304c. Execution node 304a includes cache 306a and a processor 308a. Execution node 304b includes cache 306b and processor 308b. Execution node N 304c includes cache 306c and processor 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 302a discussed above, virtual warehouse 302b includes a plurality of execution nodes as exemplified by execution node 310a, execution node 310b, and execution node 310c. Execution node 304a includes cache 312a and processor 314a. Execution node 310b includes cache 312b and processor 314b. Execution node 310c includes cache 312c and processor 314c. Additionally, virtual warehouse 302c includes a plurality of execution nodes as exemplified by execution node 316a, execution node 316b, and execution node 316c. Execution node 316a includes cache 318a and processor 320a. Execution node 316b includes cache 318b and processor 320b. Execution node 316c includes cache 318c and processor 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in data storage 106. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the data storage 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 302a implements execution node 304a and execution node 304b on one computing platform at a geographic location and implements execution node N 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in data storage 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

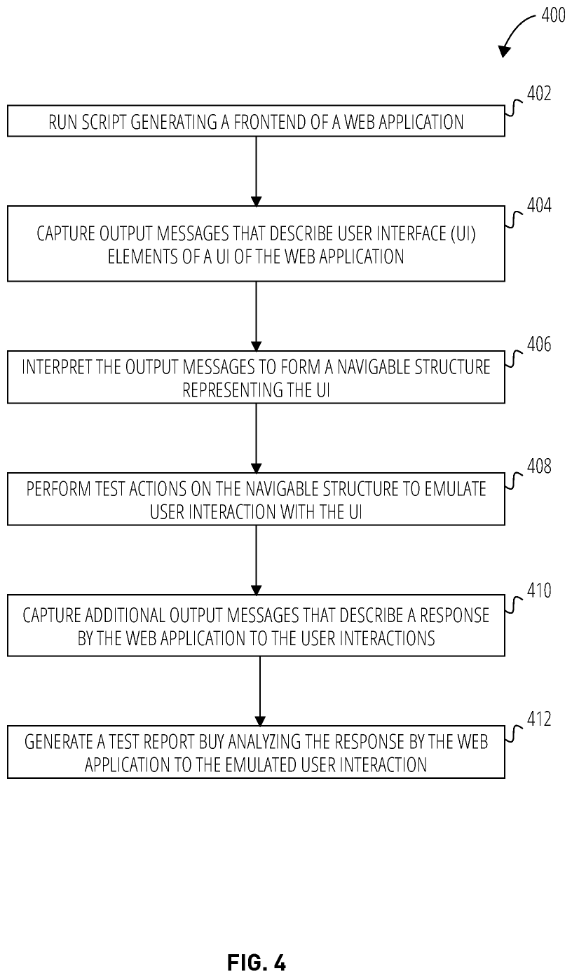

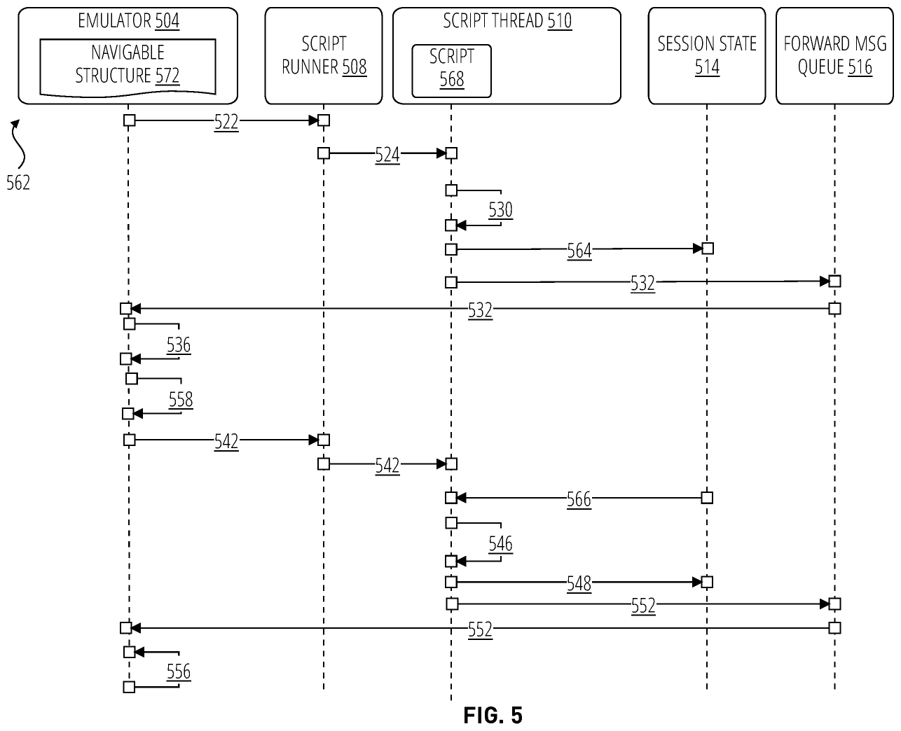

FIG. 4 illustrates an example low-code web application testing method 400 for testing a web application and FIG. 5 illustrates a low-code web application testing platform 562, according to some examples. Although the example low-code web application testing method 400 depicts a particular sequence of operations, the sequence may be altered without departing from the scope of the present disclosure. For example, some of the operations depicted may be performed in parallel or in a different sequence that does not materially affect the function of the low-code web application testing method 400. In other examples, different components of an example device or system that implements the low-code web application testing method 400 may perform functions at substantially the same time or in a specific sequence.

In operation 402, the low-code web application testing platform 562 runs a script 568 executing in a script thread 510 that generates a frontend of a web application. For example, an emulator 504 initiates the running of the script 568 by communicating a run script request 522 to a script runner 508 component within the low-code web application testing platform 562. In response to the run script request 522, the script runner 508 invokes 524 a script thread 510 in which the script 568 is executed. The script 568 defines the frontend of a web application, which includes a layout, structure, and interactive elements that an end-user interacts with. The script runner 508 sets up the execution environment, ensuring that all dependencies and context are in place for the script 568 to run effectively.

As the script 568 executes, it constructs the frontend of the web application by generating 530 a series of instructions that represent UI elements 532 of the web application. These instructions include, but are not limited to, commands to create text fields, buttons, images, and other widgets that form the interactive part of the web application. An initial execution of the script 568 establishes a baseline frontend that will be subjected to various testing scenarios.

The script 568 also determines a session state update 564 that is stored in a session state 514 datastore. The session state update 564 encompasses changes or modifications to the web application's state that result from the execution of the script 568. These changes could be due to user interactions simulated during the test, such as form submissions, selections made in dropdown menus, or toggles of switches and checkboxes. Once the script 568 has determined what updates are necessary, these updates are then committed to the session state 514 datastore. The session state 514 datastore acts as a centralized repository that maintains the state of the web application throughout a test session, ensuring continuity and consistency across multiple script runs. This process provides for the low-code web application testing platform 562 to validate the web application's behavior under various conditions and to ensure that the state transitions are occurring as expected. The session state update 564 can then be used in subsequent script runs to emulate a user's continued interaction with the web application, providing a comprehensive testing framework that closely mimics real-world usage scenarios.

The script thread 510 communicates the UI elements 532 to the forward msg queue 516. The forward msg queue 516 acts as a messaging hub within the low-code web application testing platform 562, queuing up messages that contain information about the UI elements 532 generated by the script 568. These messages are then sequentially processed and used to emulate the rendering of the web application's frontend, allowing for automated testing interactions and verifications.

By communicating the UI elements 532 to the forward msg queue 516, the script 568 effectively bridges the gap between the script execution environment and the UI emulation and interaction capabilities of the low-code web application testing platform 562. This process provides for the low-code web application testing platform 562 to accurately replicate the behavior of the web application under test and to ensure that the UI elements 532 are rendered and interacted with as they would be in a live application environment.

In operation 404, the emulator 504 of the low-code web application testing platform 562 captures output messages that describe UI elements 532 of the UI of the web application. For example, as the script 568 runs and generates these UI elements 532, the emulator 504 actively listens and captures output messages that include the UI elements 532. This capturing process involves intercepting the messages that would normally be sent to a browser client for rendering a UI. Instead of allowing the messages to proceed to an actual browser, the emulator 504 retains them for analysis and use in subsequent testing operations.

The captured output messages provide a comprehensive description of the web application's UI, including the layout of elements such as buttons, text fields, images, and other interactive components. The emulator 504 uses this information to construct a virtual representation of the web application's UI, which can then be navigated and interacted with as part of the automated testing process.

By capturing these output messages, the emulator 504 enables the low-code web application testing platform 562 to simulate how the web application would appear and function in a user's browser without the need for the application to be deployed or rendered in an actual browser environment. This capability provides for performing automated tests in a controlled and isolated manner, allowing for accurate verification of the web application's frontend against the specified requirements and user interaction scenarios.

In operation 406, the emulator 504 interprets the output messages to generate 536 a navigable structure 572 such as a Document Object Model (DOM) or the like representing the UI of the web application. For example, the emulator 504 creates a virtual representation of the web application's user interface (UI). Upon receiving the UI elements 532, that describe the various components of the web application's UI, the emulator 504 proceeds to generate a navigable structure 572 using these UI elements.

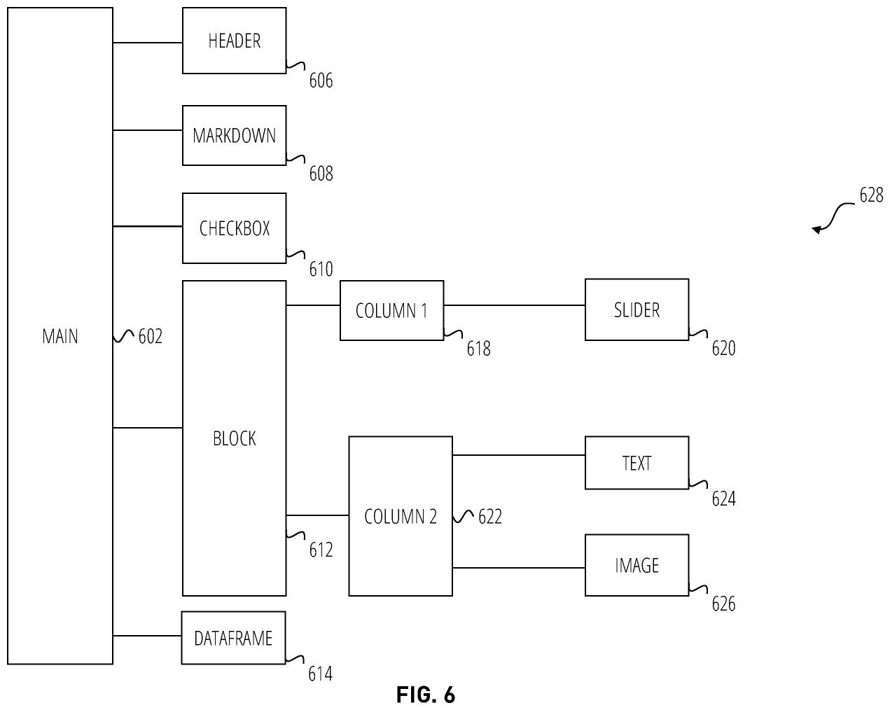

The process of generating the navigable structure 572 includes translating the UI elements 532 into a structured, hierarchical model, such as navigable structure 628 of FIG. 6, that mirrors the way a browser would construct a navigable structure 572 based on HTML and associated styling information. This virtual navigable structure 572 serves as a navigable and interactive model of the web application's UI within the low-code web application testing platform 562.

The emulator 504 systematically organizes the UI elements 532 into the navigable structure 572, ensuring that each element's relationships and attributes are accurately represented. For instance, a button described in the UI elements 532 would be instantiated in the virtual navigable structure 572 with its corresponding properties such as text, classes, and event listeners that define its behavior upon user interaction.

By generating this virtual navigable structure 572, the emulator 504 sets the stage for the subsequent steps in the testing process, where simulated user interactions can be emulated, and the web application's responses can be evaluated. This approach allows for comprehensive testing of the web application's frontend functionality without the overhead of rendering the UI in an actual browser, thus streamlining the testing process and enabling rapid feedback on the application's behavior.

In operation 408, the emulator 504 emulates 558 user interactions with the UI represented by the navigable structure 572. For example, the emulator 504, having already generated a virtual navigable structure 572 using the UI elements, proceeds to interact with the navigable structure 572 in a manner akin to user behavior. This includes actions such as clicking buttons, entering text into form fields, selecting options from dropdown menus, and triggering other event handlers that are attached to the DOM elements.

During the emulation of user interactions, the emulator 504 generates events that correspond to these user actions. For instance, if the virtual navigable structure 572 contains a button element, the emulator 504 can simulate a click event on this button, which would then trigger any associated UI changes or application behavior as if a real user had clicked the button in a live application.

In some examples, as the emulator 504 generates these event messages, it interacts with event listeners that are associated with the UI elements within the navigable structure 572. Event listeners respond to specific events, such as ‘click’, ‘input’, or ‘change’, and execute the corresponding event handling functions. The emulator 504 ensures that when an event message is generated, it is dispatched to the appropriate event listener within the navigable structure. For instance, if the emulator 504 is simulating a button click, it will generate a ‘click’ event message and dispatch it to the ‘click’ event listener attached to the button element. The event listener then executes the attached event handler function, which may result in changes to the UI elements modeled in the navigable structure or changes in the web application's behavior as if a real user had interacted with a UI element in a live application.

This emulation of user interactions provides for validating the web application's functionality and ensuring that the web application behaves as expected under various conditions. By simulating these interactions, the emulator 504 can verify that the web application responds correctly to user input, updates the UI appropriately, and maintains the correct state throughout a test session. The ability to emulate user interactions with the navigable structure 572 elements allows the low-code web application testing platform to conduct automated tests that assess the web application's performance, reliability, and user experience without manual intervention, thereby enhancing the efficiency and effectiveness of the testing process.

In operation 410, the emulator 504 captures additional output messages that describe a response by the web application to the user interactions. After simulating user interactions with the virtual navigable structure 572 elements, the emulator 504 proceeds to capture additional output messages. These additional messages describe the web application's response to the emulated user interactions. For example, the emulator 504 communicates the emulated user interactions 542 and a rerun script request to the script runner 508. The script runner 508 receives the emulated user interactions 542 and invokes the script 568 and passes the emulated user interactions 542 to the script 568. The script 568 executes in the script thread 510 and retrieves the current session state 566 from the session state 514 datastore. The script 568 executes 546 using the emulated user interactions 542 and the current session state 566 as input. The script 568 generates a session state update 548 based on the emulated user interactions 542 and the current session state 566 and stores the session state update 548 in the session state 514 datastore.

The script 568 also generates updated UI elements 552 for the UI of the web application using the emulated user interactions 542 and the session state update 548. For example, the emulated user interactions 542 represent simulated actions that a user might take when interacting with the web application, such as clicking a button, entering text, or selecting an item from a dropdown menu. These interactions are used to test how the web application behaves when subjected to user input. The session state update 548 reflects the changes in the web application's state resulting from these interactions, such as updated form values, toggled settings, or progression through a multi-step process.

As the script 568 processes the emulated user interactions 542, it dynamically generates the updated UI elements 552 to reflect the new state of the web application. The new state includes responses to the emulated user interactions 542 such as, but not limited to, altering the visibility of certain elements, changing text values, updating styling, or adding and removing elements from the UI represented by the navigable structure 572 of the emulator 504. The updated UI elements 552 are then communicated back to the emulator 504, which can further analyze the web application's behavior to verify that the UI of the web application updates correctly corresponding to the emulated user interactions 542.

By generating these updated UI elements 552, the script 568 enables the low-code web application testing platform 562 to assess the interactivity and robustness of the web application. It ensures that the web application's frontend is responsive to user input and that the UI remains consistent with the underlying application logic and state. This capability provides for automated testing, as it allows for a comprehensive evaluation of the application's functionality without the need for manual intervention, thereby streamlining the development and quality assurance processes.

The script 568 communicates the updated UI elements 552 in additional output messages that are communicated to the forward msg queue 516 and the emulator 504 receives the updated UI elements 552 from the forward msg queue 516. The capturing of these additional output messages including the updated UI elements 552 allows the emulator 504 to observe and record the dynamic behavior of the web application as it reacts to user actions. As an example, if the emulated user interactions 542 involve submitting a form, the emulator 504 captures the web application's output messages that might include confirmation messages, error messages, or any updates to the UI that result from the form submission.

In addition, the process of capturing the web application's response involves monitoring the changes in the virtual navigable structure 572 and identifying any new output messages that are generated as a result of the simulated user actions. The emulator 504 collects data such as changes to element properties, the creation of new elements, or the removal of existing ones, which all form part of the web application's response.

By capturing these additional output messages, the emulator 504 can then analyze the web application's behavior to ensure that it aligns with expected outcomes. This analysis provides for identifying any discrepancies, bugs, or areas of improvement within the web application. It also provides developers and testers with valuable insights into how the web application performs under simulated real-world conditions, thereby facilitating a thorough evaluation of the web application's functionality and user experience.

In operation 412, the emulator 504 generates 556 a test report by updating the navigable structure 572 and analyzing the response by the web application to the emulated user interactions 542 as described by the updated UI elements 552. For example, the generation of the test report involves one or more activities including, but not limited to, updating the virtual navigable structure 572 to reflect the latest state of the web application's UI and conducting an in-depth analysis of the web application's responses to the emulated user interactions 542. This analysis is based on the detailed information provided by the updated UI elements 552, which encapsulate the changes in the web application resulting from the simulated user actions.

The updated virtual navigable structure 572 serves as a snapshot of the web application's UI at a specific instance after user interactions have been emulated. The emulator 504 examines this snapshot to verify that each UI element's behavior and presentation align with the expected outcomes. For example, if a user interaction should trigger a new form to appear, the emulator 504 checks for the presence of this form in the updated virtual navigable structure 572.

The test report generated by the emulator 504 is a synthesis of these analyses. The test document documents the outcomes of the simulated interactions, noting any discrepancies, errors, or deviations from the expected behavior. The report may include details such as success indicators, failure points, performance metrics, and other relevant data that provide insights into the web application's functionality and user experience.

By generating this test report, the emulator 504 provides developers and testers with valuable feedback on the web application's performance. This feedback provides for identifying areas for improvement, debugging issues, and validating that the application meets its design specifications. The automated nature of this process ensures that the testing is both thorough and efficient, facilitating a streamlined development cycle and helping to maintain high standards of quality for the web application.

In some examples, a process of running and rerunning the script 568 is performed within a backend web server environment, which acts as the command center for the web application's operations. Within this environment, the script 568 is initially executed to construct the web application's frontend, laying out the interactive elements and visual components as defined by web application. When a rerun is triggered during a testing process (e.g., because of a user interaction or a change in the web application's state) the backend web server responds by reinitiating the script execution. This rerun provides for a reevaluation of the web application in the context of new or updated parameters. The backend web server ensures that the current state, including any user inputs or data changes, is incorporated into the script 568 execution context, leading to an updated and accurate representation of the web application's frontend.

In some examples, capturing of output messages and additional output messages involves interception of messages typically destined for a browser client. These intercepted messages provide for rendering the user interface (UI) of the web application within a testing context. The low-code web application testing platform 562 monitors the flow of messages between the backend server and the client. As the server generates output messages that instruct the browser on how to construct and update the UI, the low-code web application testing platform 562 acts as a gatekeeper, capturing these messages before they reach their intended destination. The captured messages contain information about the UI elements, such as layout instructions, style definitions, and behavioral scripts. By intercepting these messages, the low-code web application testing platform 562 gains access to the raw data that would otherwise be used to paint the UI on the screen of a browser. This data is then repurposed to create the navigable structure 572.

In some examples, the generation of a test report encompasses a detailed analysis of the web application's responses to the emulated user interactions. This analytical process is a component of the low-code web application testing platform 562, as it scrutinizes the behavior of the web application following the simulated actions that mimic real user engagement. The low-code web application testing platform 562 observes how the web application reacts to each emulated interaction, whether it be a button click, form submission, or navigation event. An objective of this analysis is to ascertain whether the web application's response aligns with the predefined expected outcomes. These outcomes are benchmarks established based on the application's design specifications and user requirements. As the low-code web application testing platform 562 evaluates the web application's responses, the low-code web application testing platform 562 compares the actual behavior observed within the navigable structure against these benchmarks. The low-code web application testing platform 562 checks for the correct display of messages, the appropriate transition between views, the accurate capture of user input, and the proper execution of dynamic content updates.

The test report generated as a result of this analysis serves as a comprehensive record of the web application's performance under test conditions. The test report documents successes, identifies failures or anomalies, and provides insights into areas that may require further development or refinement. By including such an analysis within the test report, the low-code web application testing platform 562 ensures that stakeholders are well-informed about the web application's readiness and reliability, facilitating informed decisions about its release and deployment.

In some examples, the process of validating the behavior of the web application includes a comparison between the actual session state 514 of the web application following emulated user interactions and a predetermined expected state. This validation step provides for a testing framework, serving as a checkpoint to ensure that the web application behaves in accordance with its design specifications and user experience requirements.

The predetermined expected state represents a blueprint of the desired conditions and outcomes that should result from specific user interactions. It encompasses aspects such as the expected visual layout, data values, navigation flow, and any other dynamic changes that should occur within the web application in response to user actions. This expected state is often derived from the web application's requirements documentation, user stories, or acceptance criteria established during the development phase.

In some examples, upon the emulation of user input—such as clicking a button, submitting a form, or navigating to a different section of the application—the low-code web application testing platform 562 captures the actual state of the web application as stored in the session state 514. This actual state is a snapshot of the web application's UI elements, data fields, and navigational context at that moment in the testing sequence. The low-code web application testing platform 562 then conducts a side-by-side evaluation, comparing this actual state to the expected state.

In some examples, the validation process involves checking for congruence in UI element visibility, correctness of displayed data, adherence to the intended navigational paths, and the proper triggering of events and updates. Discrepancies between the actual and expected states are flagged for review, indicating potential issues that may need to be addressed by the development team.

By incorporating this validation step, the low-code web application testing platform 562 provides a robust mechanism for ensuring that the web application not only functions correctly on a technical level but also delivers the intended user experience. This contributes to a higher quality product and instills confidence in the application's performance before it reaches the end-users.

In some examples, the low-code web application testing platform 562 is implemented within a User Defined Function (UDF) framework, and the web application under test is a UDF application. UDF applications often operate within larger systems or databases, providing specialized functionality that extends beyond the built-in capabilities of the hosting environment. The low-code web application testing platform 562, therefore, is tailored to interact with the UDF framework, ensuring that the UDF application adheres to the expected performance and behavior standards.

The UDF framework typically allows users to write custom functions in a programming language supported by the system, such as SQL, Python, or Java. These functions can then be invoked within the system's environment, executing custom logic and returning results that can be further utilized within the system. The UDF application, being a collection of such functions, represents a complex integration of custom logic into the system's workflow.

When the low-code web application testing platform 562 is used to test a UDF application, the low-code web application testing platform 562 simulates the invocation of these user-defined functions as part of the testing process. The emulator 504 emulates the input that would typically be provided to the UDF application and monitors the output and side effects. It validates the behavior of the UDF application by executing the functions with various inputs and comparing the actual state of the system after execution with a predetermined expected state.

This comparison involves assessing whether the UDF application processes data correctly, interacts with the system as intended, and maintains the integrity of the system's operations. The testing framework ensures that the UDF application does not introduce errors, degrade performance, or produce unintended consequences when integrated into the larger system.

By implementing the method within a UDF framework, the testing process is specifically adapted to the unique challenges and requirements of testing UDF applications. It provides developers with the tools to rigorously test their custom functions, ensuring that they perform reliably and as intended within the system's ecosystem.

FIG. 6 is an illustration of a navigable structure 628, according to some examples. A navigable structure is generated by a low-code web application testing platform to model the user interface of a web application for testing. The navigable structure 628 represents the layout and organization of the UI elements within a web application as constructed by a low-code web application testing platform. This structure is a hierarchical representation of the UI components, akin to a virtual DOM, which is used during the testing process to emulate user interactions and analyze the web application's behavior.

At the top level of the navigable structure 628, is a main section 602, which serves as a root container for the UI elements. The main section 602 is akin to the main content area of a web application where various UI components are displayed to the user.

Within the main section 602, several UI elements are organized as follows:
header 606: This element includes the title or heading of the web application, providing users with context about the content or functionality of the app.
markdown 608: This element is used for displaying text with possible formatting based on a markdown language. It can include various typographic elements such as headers, bold text, italics, and lists.
checkbox 610: This interactive element allows users to make selections, often used for toggling features on or off within the application.
block 612: This container element groups together a set of related UI elements, which can include both static and interactive components.
dataframe 614: This element is used to display tabular data in a structured format, similar to a spreadsheet or database table.
Adjacent to the main section 602, the navigable structure 628 includes two columns:
column 1 618: This sub-container holds UI elements that are part of the first column in a multi-column layout. It may contain elements such as slider 620 that is an interactive element that allows users to select a value from a range by sliding a handle along a track.
column 2 622: This sub-container corresponds to the second column in the layout and may include elements such as, but not limited to:
   text 624: This element displays static text content to the user.
   image 626: This element is used to display an image within the application's UI.

The navigable structure 628 is designed to be traversed and manipulated by the low-code web application testing platform, which can interact with the elements to simulate user actions such as clicking, typing, and navigating. By doing so, the low-code web application testing platform can verify the web application's functionality and ensure that the web application responds correctly to user inputs. The navigable structure 628 also allows for the inspection of UI changes in response to simulated interactions, which is used for validating the dynamic aspects of the web application during the testing process.

In some examples, the navigable structure 628 is accessed and manipulated using a testing program written in a scripting language that can automatically manipulate elements of the navigable structure 628 during testing of a web application. For example, the navigable structure 628 serves as a blueprint for the web application's user interface, providing a comprehensive map of all UI elements that a user would interact with. A testing program, crafted in a scripting language such as, but not limited to, Python, JavaScript and the like, operates on the navigable structure 628 to conduct automated tests. In some examples, the testing program systematically accesses each element within the navigable structure 628, simulating user actions such as clicks, text input, and navigation events.

In some examples, the testing program operates by sending commands directly to the elements of the navigable structure 628, bypassing the need for manual interaction. For example, a testing program can select a checkbox element within the navigable structure 628 and toggle its state, or the testing program can input a series of characters into a text field to test form submission processes. A scripting language's set of libraries and functions allows the testing program to emulate complex user behaviors with precision and consistency.

In some examples, during the testing process, the program not only triggers actions but also listens for and records the web application's responses. It evaluates whether the dynamic changes to the navigable structure 628 (e.g., the appearance of a confirmation message or the updating of a data table) align with the expected outcomes defined in the test cases. This automated interaction and validation cycle enables rapid and thorough testing of the web application, ensuring that each component functions as intended before deployment or updates are released to end-users.

By utilizing the navigable structure 628 in this way, the testing program transforms the typically labor-intensive testing phase into an efficient, automated procedure. This approach not only accelerates the development cycle but also enhances the reliability of the web application by uncovering potential issues early in the development process.

In some examples, beyond the basic interaction tests, the navigable structure 628 can be utilized for a variety of automated tests to ensure comprehensive coverage of the web application's functionality. These tests may include, but are not limited to:
Regression Tests: To confirm that recent code changes have not adversely affected existing functionalities. The testing program can re-run a suite of tests against the navigable structure 628 after each update to the application.
User Journey Tests: To simulate and validate complete workflows that a user might undertake. The testing program can navigate through the structure 628, executing a series of actions that represent a typical user session.
Accessibility Tests: To ensure the application is usable by people with disabilities. The testing program can check the navigable structure 628 for compliance with accessibility standards, such as the Web Content Accessibility Guidelines (WCAG).
Performance Tests: To measure how the application behaves under load. While the navigable structure 628 itself is a representation, the testing program can use it to trigger actions that stress test the application's performance, such as rapid interactions or large data submissions.
Compatibility Tests: To verify that the application works across different browsers and devices. The testing program can manipulate the navigable structure 628 in various environments to ensure consistent behavior.
Security Tests: To identify vulnerabilities within the application. The testing program can attempt to exploit potential security flaws in the application logic as represented by the navigable structure 628.
Localization Tests: To check that the application correctly supports multiple languages and regional settings. The testing program can verify text and format changes in the navigable structure 628 when different locales are applied.
UI Consistency Tests: To confirm that the UI remains consistent when changes are made. The testing program can compare elements in the navigable structure 628 against a set of UI standards or snapshots.

In some examples, the navigable structure 628 is accessed and manipulated using a Graphical User Interface (GUI) that provides a UI for a user to inspect the elements of the navigable structure 628 and manipulate them. The GUI provides intuitive tools for manipulating the elements within the navigable structure 628. Testers can perform actions like dragging and dropping elements to new positions, modifying text within fields, or triggering event handlers associated with UI components. These interactions are reflected in real-time within the GUI, offering immediate feedback on how the elements of the navigable structure 628 respond to user input.

In some examples, the GUI includes features for recording and scripting test scenarios. Testers can create sequences of actions to form test cases, which can then be saved, replayed, and shared with other team members. This capability enhances collaboration and ensures consistency in test execution.

By integrating the navigable structure 628 with a GUI, the testing process becomes more accessible, especially for those who may not be well-versed in scripting languages. It democratizes the testing process, enabling a broader range of users to contribute to the quality assurance of the web application. The GUI thus serves as a bridge between the technical representation of the navigable structure 628 and the practical needs of hands-on testing.

In some examples, the emulation of user interactions with a navigable structure is achieved through the utilization of an Application Programming Interface (API). This API provides a suite of functions and methods that programmatically simulate the various actions a user might take when engaging with the web application's UI. By leveraging this API, the low-code web application testing platform can systematically replicate clicks, keystrokes, form submissions, and other events that would typically be initiated by a user in a live application environment.

The API interacts directly with the navigable structure, sending commands to the elements within the navigable structure as if they were being triggered by real user input. For example, the API can invoke a method to simulate a mouse click on a button, input text into a text field, select an item from a dropdown, or even trigger complex gestures like drag-and-drop operations. Each of these simulated interactions is processed by the navigable structure, which is then updated accordingly, reflecting the changes that would occur in the actual UI.

This method of emulating user interactions is highly efficient, as it bypasses the need for a physical user interface and operates entirely within the software realm. It allows for the execution of comprehensive test suites that cover a wide array of user scenarios, ensuring that the web application behaves as expected under various conditions. Moreover, the API-driven approach to interaction emulation facilitates the automation of regression tests, usability tests, and acceptance tests, contributing to a more robust and reliable web application development lifecycle.

In some examples, the emulation of user interactions with the UI elements of the navigable structure 628 is accomplished by generating equivalent messages that represent user actions. This process involves the low-code web application testing platform creating a series of messages that mimic the data a browser would typically receive as a result of a user's direct interaction with the web application. These messages are crafted to reflect the various types of user input, such as clicking a button, entering text, selecting options from a menu, or any other action that a user might perform.

The low-code web application testing platform, through an API, dispatches these synthetic messages to the navigable structure, which is designed to interpret and process them as if they were genuine user interactions. As the navigable structure receives a message indicating, for example, that a button has been clicked, it triggers the same events and updates that would occur if a real user had performed the click within an actual browser session.

This method of emulating user interactions ensures that the testing environment closely replicates the live environment of the web application, providing an accurate assessment of the application's behavior and response to user input. It allows for the validation of the UI's functionality and the verification of the application's logic and flow. By generating these equivalent messages, the low-code web application testing platform can conduct a thorough examination of the web application's interactive capabilities, ensuring a user-friendly experience upon deployment.

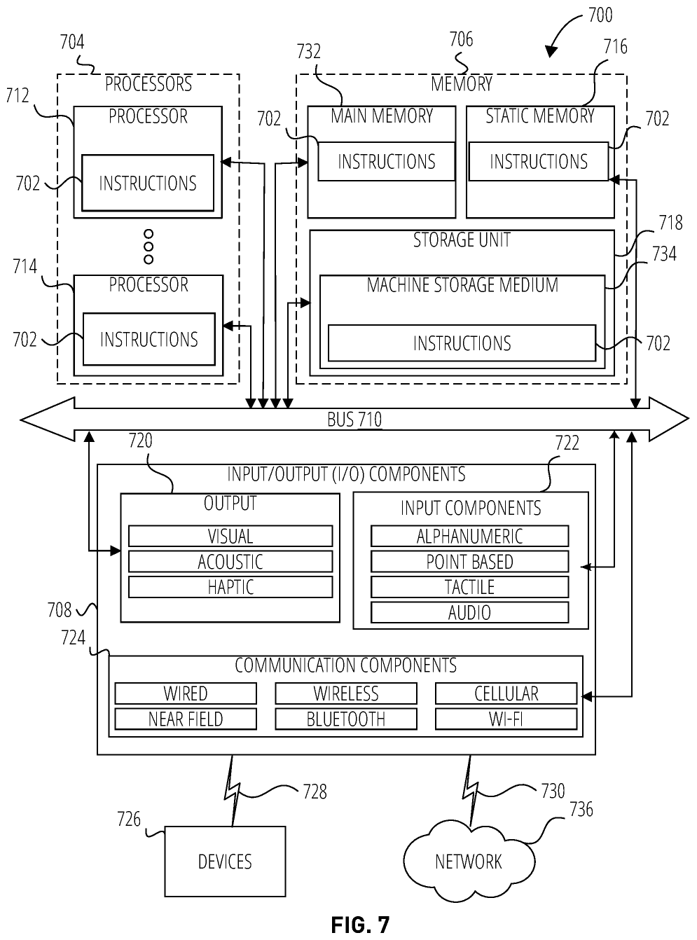

FIG. 7 illustrates a diagrammatic representation of a machine 700 in the form of a computer system within which a set of instructions may be executed for causing the machine 700 to perform any one or more of the methodologies discussed herein, according to examples. Specifically, FIG. 7 shows a diagrammatic representation of the machine 700 in the example form of a computer system, within which instructions 702 (e.g., software, a program, an application, an applet, an application, or other executable code) for causing the machine 700 to perform any one or more of the methodologies discussed herein may be executed. For example, the instructions 702 may cause the machine 700 to execute any one or more operations of any one or more of the methods described herein. In this way, the instructions 702 transform a general, non-programmed machine into a particular machine 700 (e.g., the compute service manager 104, the execution platform 110, and the data storage devices 1 to N of data storage 106) that is specially configured to carry out any one of the described and illustrated functions in the manner described herein.

In alternative examples, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 702, sequentially or otherwise, that specify actions to be taken by the machine 700. Further, while only a single machine 700 is illustrated, the term “machine” shall also be taken to include a collection of machines that individually or jointly execute the instructions 702 to perform any one or more of the methodologies discussed herein.

The machine 700 includes hardware processors 704, memory 706, and I/O components 708 configured to communicate with each other such as via a bus 710. In some examples, the processors 704 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, multiple processors as exemplified by processor 712 and a processor 714 that may execute the instructions 702. The term “processor” is intended to include multi-core processors that may comprise two or more independent processors (sometimes referred to as “cores”) that may execute instructions 702 contemporaneously. Although FIG. 7 shows multiple processors 704, the machine 700 may include a single processor with a single core, a single processor with multiple cores (e.g., a multi-core processor), multiple processors with a single core, multiple processors with multiple cores, or any combination thereof.

The memory 706 may include a main memory 732, a static memory 716, and a storage unit 718 including a machine storage medium 734, all accessible to the processors 704 such as via the bus 710. The main memory 732, the static memory 716, and the storage unit 718 store the instructions 702 embodying any one or more of the methodologies or functions described herein. The instructions 702 may also reside, completely or partially, within the main memory 732, within the static memory 716, within the storage unit 718, within at least one of the processors 704 (e.g., within the processor's cache memory), or any suitable combination thereof, during execution thereof by the machine 700.

The input/output (I/O) components 708 include components to receive input, provide output, produce output, transmit information, exchange information, capture measurements, and so on. The specific I/O components 708 that are included in a particular machine 700 will depend on the type of machine. For example, portable machines such as mobile phones will likely include a touch input device or other such input mechanisms, while a headless server machine will likely not include such a touch input device. It will be appreciated that the I/O components 708 may include many other components that are not shown in FIG. 7. The I/O components 708 are grouped according to functionality merely for simplifying the following discussion and the grouping is in no way limiting. In various examples, the I/O components 708 may include output components 720 and input components 722. The output components 720 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 722 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 708 may include communication components 724 operable to couple the machine 700 to a network 736 or devices 726 via a coupling 730 and a coupling 728, respectively. For example, the communication components 724 may include a network interface component or another suitable device to interface with the network 736. In further examples, the communication components 724 may include wired communication components, wireless communication components, cellular communication components, and other communication components to provide communication via other modalities. The devices 726 may be another machine or any of a wide variety of peripheral devices (e.g., a peripheral device coupled via a universal serial bus (USB)). For example, as noted above, the machine 700 may correspond to any one of the compute service manager 104, the execution platform 110, and the devices 726 may include the data storage device 226 or any other computing device described herein as being in communication with the data platform 102 or the data storage 106.

The various memories (e.g., 706, 716, 732, and/or memory of the processor(s) 704 and/or the storage unit 718) may store one or more sets of instructions 702 and data structures (e.g., software) embodying or utilized by any one or more of the methodologies or functions described herein. These instructions 702, when executed by the processor(s) 704, cause various operations to implement the disclosed examples.

Described implementations of the subject matter can include one or more features, alone or in combination as illustrated below by way of example:

Example 1 is a machine-implemented method for low-code automated testing of web applications, comprising: running a script to simulate a frontend of a web application; capturing output messages that describe User Interface (UI) elements of a UI of the web application; interpreting the output messages to form a navigable structure representing the UI; performing test actions on the navigable structure to emulate user interactions with the UI elements; rerunning the script using the user interactions; capturing additional output messages that describe a response by the web application to the user interactions; and generating a test report based on the response by the web application to the emulated user interactions.

In Example 2, the subject matter of Example 1 includes, wherein the running and rerunning of the script includes executing the script in a backend web server environment.

In Example 3, the subject matter of Examples 1-2 includes, using a low-code platform to facilitate the creation of the UI elements of the web application.

In Example 4, the subject matter of Examples 1-3 includes, wherein capturing the output messages and the additional output messages includes intercepting messages normally sent to a browser client for rendering the UI.

In Example 5, the subject matter of Examples 1-4 includes, wherein interpreting the output messages to form a navigable structure includes creating a virtual representation of the UI of the web application UI that mirrors a structure expected by a browser.

In Example 6, the subject matter of Examples 1-5 includes, wherein emulating user interactions with the navigable structure includes using an Application Programming Interface (API) to emulate the user interactions with a virtual Document Object Model.

In Example 7, the subject matter of Examples 1-6 includes, emulating the user interactions with the UI elements by generating equivalent messages representing user actions.

In Example 8, the subject matter of Examples 1-7 includes, wherein generating a test report includes analyzing the responses of the web application to the emulated user interactions to determine if the response matches one or more expected outcomes.

In Example 9, the subject matter of Examples 1-8 includes, validating a behavior of the web application by comparing an actual state of the web application after emulated user input with a predetermined expected state.

In Example 10, the subject matter of Examples 1-9 includes, wherein the method is implemented within a User Defined Function (UDF) framework, and the web application is a UDF application.

Example 11 is at least one machine-readable medium including instructions that, when executed by processing circuitry, cause the processing circuitry to perform operations to implement of any of Examples 1-10.

Example 12 is an apparatus comprising means to implement of any of Examples 1-10.

Example 13 is a system to implement of any of Examples 1-10.

Example 14 is a method to implement of any of Examples 1-10.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 736 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 736 or a portion of the network 736 may include a wireless or cellular network, and the coupling 730 may be a Code Division Multiple Access (CDMA) connection, a Global System for Mobile communications (GSM) connection, or another type of cellular or wireless coupling. In this example, the coupling 730 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 702 may be transmitted or received over the network 736 using a transmission medium via a network interface device (e.g., a network interface component included in the communication components 724) and utilizing any one of a number of well-known transfer protocols (e.g., hypertext transfer protocol (HTTP)). Similarly, the instructions 702 may be transmitted or received using a transmission medium via the coupling 728 (e.g., a peer-to-peer coupling) to the devices 726. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 702 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

What is claimed is:

1. A machine-implemented method for low-code automated testing of web applications, comprising:
running a script to simulate a frontend of a web application;
capturing output messages that describe User Interface (UI) elements of a UI of the web application;
interpreting the output messages to form a navigable structure representing the UI;
performing test actions on the navigable structure to emulate user interactions with the UI elements;
rerunning the script using the user interactions;
capturing additional output messages that describe a response by the web application to the user interactions; and
generating a test report based on the response by the web application to the emulated user interactions.

2. The machine-implemented method of claim 1, wherein the running and rerunning of the script includes executing the script in a backend web server environment.

3. The machine-implemented method of claim 1, further comprising using a low-code platform to facilitate creation of the UI elements of the web application.

4. The machine-implemented method of claim 1, wherein capturing the output messages and the additional output messages includes intercepting messages normally sent to a browser client for rendering the UI.

5. The machine-implemented method of claim 1, wherein interpreting the output messages to form a navigable structure includes creating a virtual representation of the UI of the web application UI that mirrors a structure expected by a browser.

6. The machine-implemented method of claim 1, wherein emulating user interactions with the navigable structure includes using an Application Programming Interface (API) to emulate the user interactions with the navigable structure.

7. The machine-implemented method of claim 1, further comprising emulating the user interactions with the UI elements by generating equivalent messages representing user actions.

8. The machine-implemented method of claim 1, wherein generating a test report includes analyzing the responses of the web application to the emulated user interactions to determine if the response matches one or more expected outcomes.

9. The machine-implemented method of claim 1, further comprising validating a behavior of the web application by comparing an actual state of the web application after emulated user input with a predetermined expected state.

10. The machine-implemented method of claim 1, wherein the web application is a User Defined Function (UDF) implemented within a UDF framework.

11. A data platform comprising:
at least one processor; and
at least one memory storing instructions that, when executed by the at least one processor, cause the data platform to perform operations comprising:
running a script to simulate a frontend of a web application;
capturing output messages that describe User Interface (UI) elements of a UI of the web application;
interpreting the output messages to form a navigable structure representing the UI;
performing test actions on the navigable structure to emulate user interactions with the UI elements;
rerunning the script using the user interactions;
capturing additional output messages that describe a response by the web application to the user interactions; and
generating a test report based on the response by the web application to the emulated user interactions.

12. The data platform of claim 11, wherein the running and rerunning of the script includes executing the script in a backend web server environment.

13. The data platform of claim 11, wherein the operations further comprise using a low-code platform to facilitate creation of the UI elements of the web application.

14. The data platform of claim 11, wherein capturing the output messages and the additional output messages includes intercepting messages normally sent to a browser client for rendering the UI.

15. The data platform of claim 11, wherein interpreting the output messages to form a navigable structure includes creating a virtual representation of the UI of the web application UI that mirrors a structure expected by a browser.

16. The data platform of claim 11, wherein emulating user interactions with the navigable structure includes using an Application Programming Interface (API) to emulate the user interactions with the navigable structure.

17. The data platform of claim 11, wherein the operations further comprise emulating the user interactions with the UI elements by generating equivalent messages representing user actions.

18. The data platform of claim 11, wherein generating a test report includes analyzing the responses of the web application to the emulated user interactions to determine if the response matches one or more expected outcomes.

19. The data platform of claim 11, wherein the operations further comprise validating a behavior of the web application by comparing an actual state of the web application after emulated user input with a predetermined expected state.

20. The data platform of claim 11, wherein the web application is a User Defined Function (UDF) implemented within a UDF framework.

21. A machine-storage medium comprising instructions that, when executed by one or more processors of a machine, cause the machine to perform operations comprising:
running a script to simulate a frontend of a web application;
capturing output messages that describe User Interface (UI) elements of a UI of the web application;
interpreting the output messages to form a navigable structure representing the UI;
performing test actions on the navigable structure to emulate user interactions with the UI elements;
rerunning the script using the user interactions;
capturing additional output messages that describe a response by the web application to the user interactions; and
generating a test report based on the response by the web application to the emulated user interactions.

22. The machine-storage medium of claim 21, wherein the running and rerunning of the script includes executing the script in a backend web server environment.

23. The machine-storage medium of claim 21, wherein the operations further comprise using a low-code platform to facilitate creation of the UI elements of the web application.

24. The machine-storage medium of claim 21, wherein capturing the output messages and the additional output messages includes intercepting messages normally sent to a browser client for rendering the UI.

25. The machine-storage medium of claim 21, wherein interpreting the output messages to form a navigable structure includes creating a virtual representation of the UI of the web application UI that mirrors a structure expected by a browser.

26. The machine-storage medium of claim 21, wherein emulating user interactions with the navigable structure includes using an Application Programming Interface (API) to emulate the user interactions with the navigable structure.

27. The machine-storage medium of claim 21, wherein the operations further comprise emulating the user interactions with the UI elements by generating equivalent messages representing user actions.

28. The machine-storage medium of claim 21, wherein generating a test report includes analyzing the responses of the web application to the emulated user interactions to determine if the response matches one or more expected outcomes.

29. The machine-storage medium of claim 21, wherein the operations further comprise validating a behavior of the web application by comparing an actual state of the web application after emulated user input with a predetermined expected state.

30. The machine-storage medium of claim 21, wherein the web application is a User Defined Function (UDF) implemented within a UDF framework.
